(19) United States
(12) Patent Application Publication
(10) Pub. No.: US 2012/0187053 A1
(43) Pub. Date: Jul. 26, 2012

(54) METHOD AND DEVICE FOR PREPARING A PROCESSING LIQUID ACCUMULATED IN THE COURSE OF A CONTAINER CLEAINING

(75) Inventor: Hartmut Evers, Bad Kreuznach (DE)

(73) Assignee: KHS GMBH, Dortmund (DE)

(21) Appl. No.: 13/498,351

(22) PCT Filed: Nov. 30, 2010
(86) PCT No.: PCT/EP10/07230

§ 371 Date: Mar. 27, 2012

(30) Foreign Application Priority Data
Dec. 4, 2009 (DE) 10 2009 056 726.7

(51) Int. Cl. B01D 37/02; B08B 3/14; D21C 5/02; B01D 39/04

(52) U.S. Cl. 210/778; 210/777; 210/173; 536/56

(57) ABSTRACT

The invention relates to the use of labels (3) which are obtained and prepared with a processing liquid (1) in the course of a container handling, in particular a container cleaning, as filtering aids (5) for the layered deposition filtration of the processing liquid (1) to be cleaned.

The invention relates to a method for treating a processing liquid accumulated in the course of a container treatment and in particular container cleaning, whereby an additive is added to the processing liquid and the mixture is filtered.—Within the scope of the invention, container treatment means any treatment of a container with a processing liquid. This particularly includes container cleaning. This work is done mainly using lyes as processing liquid.

In the case of container cleaning, in particular that of bottles and here of re-usable bottles, the work is regularly done with one or more lye baths. The lye treatment is used on the one hand to wash off impurities of the re-usable bottles or re-usable containers and on the other to loosen or completely remove any applied imprints such as for example labels. As the objective, the appropriately cleaned container is then immediately refilled and for example equipped with a new label.—To assist the detaching of labels from the outer container jacket, the prior art makes use inter alia of nozzle devices in order to improve the label detachment (cf. DE 10 2005 026 080 A1). The detached and removed labels are separated out and are usually disposed of as waste.

While the use of for example lye as a processing liquid has proven its worth in practice, an increasing contamination of the lye in particular and of the processing liquid is general is unavoidable as cleaning time passes. It is for this reason that there have been a number of attempts in the prior art to treat the lye and/or generally a processing liquid in such cleaning operations. Thus WO 2009/010164 A1 for example describes a complicated method with different filters which are back-washed additionally and in different sequences. In view of the increasing pressure of cost this is counter-productive however because it involves complex plant engineering.

As part of the generic teaching according to EP 0 264 596 B1 a method for disposal of caustic solution from cleaning machines is proposed in which suspended solids are settled out over a number of hours. The sludge and part of the caustic solution remaining in settling tanks are drawn off and passed to a thickening system. In the thickening system the sludge is further concentrated, for which a flocculant can be used. As flocculant the said publication proposes a polymer electrolyte which is relatively expensive to use.

In a comparable method for treating process water from a bottle cleaning machine according to DE 196 25 184 A1, the process water from cleaning undergoes reverse osmosis in a filter. In this way clean water is obtained and subsequently neutralised, for example by carbon dioxide. A conditioning with germicidal media is also carried out. The clean water treated in this way can then be re-used in the bottle cleaning machine. In this context again however, the process and plant engineering complexity is high.—This is where the invention seeks to provide an overall remedy.

The invention is based on the technical problem of further developing a method for treating processing liquid of the type described at the outset which accumulates in the course of a container treatment and in particular container cleaning, such that the complexity and the costs are reduced. A suitable device is to be proposed as well.

In order to resolve this technical problem, it is proposed that in a generic method for the treatment of processing liquid accumulated in the course of a container treatment, in particular container cleaning, a filtering aid for the precoat filtration of the processing liquid be used as additive added to the processing liquid.

Devices and methods for the cleaning of liquids by way of a so-called precoat filtration are previously known and are in widespread use for the cleaning of the product, in particular in beer production. DE 10 2007 038 828 A1 for example discloses such a method in which a mixture of cellulose fibres of different lengths is used as a filtering aid.

According to the invention therefore the processing liquid used in the course of the container treatment/container cleaning undergoes a special treatment/cleaning, namely in the sense of a precoat filtration. It should be emphasised here that processing liquid within the scope of the invention means all liquids used during a container cleaning/container treatment. They include not only cleaning liquids but also for example flushing liquids, cooling liquids etc. as well as mixtures of the said liquids.

It is known in principle that in a cake filtration, a flowing liquid is passed through a porous body. The ‘contaminants’ present in the liquid are retained in the filter cake either by adhesion and/or absorption, but primarily by screening effect. The type of retention which dominates depends on the composition of the filtering aid. In filtering, the clarified phase is referred to as filtrate and the solid matter that settles onto the support layer as filter cake.

Unlike the generic prior art according to EP 0 264 596 B1, this is not done with a flocculant as additive with subsequent settling and filtration, but instead the additive which is added to the processing liquid which is to be treated acts as a filtering aid and serves to build up a precoat filter layer. This precoat filter layer composed of the additive or filtering aid acts as an actual filtration layer. The addition of flocculants is not only unnecessary, it is actually disruptive.

According to the invention the described precoat filtration can be effected during pressure application or in the sense of a suction application. In the case of the former pressure variant, in a closed filter the processing liquid which is to be cleaned is pressed through the filtration layer that is built up of the additive or filtering aid. In the case of the suction variant on the other hand, the processing liquid is sucked through the filtration layer in question in an open or closed container or filter. Both basic variants are conceivable and possible within the scope of the invention.

No rinsing usually takes place in the case of precoat filtration as it does with other filter systems. Instead it is sufficient to reverse the direction of flow of the processing liquid that is to be cleaned, the unfiltrate, and of the cleaned processing liquid, the filtrate. This is because this reversal of the direction of flow generally ensures that the filtration layer forming on a support structure or precoat filter device together with the impurities therein embedded, the so-called filter cake, is blown off or detached from the support structure. A new precoat filtration can then be carried out subsequent to this.

The support structure for building up the filtration layer out of the additive and/or filtering aid can basically be a horizontal support structure or also a vertical support structure. In the former case the filter exhibits a horizontal precoat filter device. In the case of the latter variant the filter is equipped with one or with a plurality of vertical precoat filter devices. This may involve one or a plurality of filter candles, as is explained in more detail hereinbelow and with reference to the embodiment.

The filtering aid can basically be an external additive which is added to the processing liquid. A variant in which the filtering aid originates from the container cleaning as an internal additive and is added to the processing liquid is given very particular preference however. In other words, an additive which occurs during the container cleaning/during the process of container cleaning is used as filtering aid. According to the invention this internal additive which has in the past been treated so to speak as “waste” is now added to the processing liquid and used as filtering aid for the precoat filtration of the processing liquid. In this context the filtering aid can be added to the processing liquid in any phase on its way to the precoat filter or even only when it is in the precoat filter.

In this way hitherto untapped resources can be used advantageously and the complexity of both process and plant engineering significantly reduced. The invention actually recommends that the filtering aid be advantageously extracted from labels gained and separated out in the course of the container cleaning. In other words, some or all of the labels removed in the course of the container cleaning from the containers to be cleaned are treated and—contrary to prior art—not disposed of. Instead the treated labels experience an additional use in so far as they are added as filtering aids to the processing liquid that is to be cleaned. In this context the treatment of the labels is as a rule confined to the labels being ground, for example in a cone grinder.

The filtering aid generally works on the basis of cellulose fibres. Such cellulose fibres are in any event predominantly present in and/or form the main constituent of the labels which are usually manufactured from paper. Consequently therefore, when the labels have been detached and treated in the manner described, the cellulose fibres in question can be used to advantage as filtering aids for the described precoat filtration for treating the processing liquid.

This is as a rule carried out with cellulose fibres whose fibre length is within the μm range. The cellulose fibres typically have a fibre length of less than 500 μm, in particular a fibre length of approx. 400 μm and below. The support structure naturally takes account of the fibre length and is equipped with a corresponding pore size of for example 100 μm in order to ensure that the cellulose fibres of the stated fibre length are safely carried by the support structure and can be used to build up the filter cake.

The process control during the treating of the labels and/or generally of the cellulose fibres takes account of the pore size of the support structure. For this purpose the labels to be treated are ground in a grinder until a mean fibre length of for example 400 μm or 500 μm is observed. In any event the grinder is controlled according to the pore size the support structure [sic] so that the cellulose fibres can settle and build up on the support structure as they form the filtration layer.

The basic use of cellulose fibres in precoat filtration has been known for a long time and is mentioned for example in DE 77 03 620 U1 alongside other conceivable filtering aids such as diatomaceous earth. Nevertheless the state of the art has not so far believed it possible to use as filtering aid the cellulose which is in any case accumulated in the course of the container cleaning in the shape of the detached labels. The described approach effectively means that advantage can be taken of a particularly substantial cost savings potential. This is due firstly to a reduced consumption of lye and hence a reduced waste water load, and secondly to maintaining the activity of the lye through the described cleaning with the help of the precoat filtration. A lower energy consumption is also observed because the lye which is cleaned as part of the inventive method can be circulated and after it has been extracted from the filter and cleaned in a relatively short period of time again reaches an associated cleaning machine or container cleaning machine.

Because the lye or more generally the processing liquid is usually heated up for use in cleaning, the inventively cleaned lye or processing liquid requires only minimal heating up. By contrast, the state of the art settling process lasting several hours e.g. according to the generic EP 0 264 596 B1 requires an energy-intensive subsequent heating up process of the necessarily cooling lye.

Quite apart from this of course, the detached labels are recycled for an additional benefit. The filter cake which is thus formed with the help of the treated labels can subsequently be disposed of in a known manner together with the other separated out and detached labels. An additional disposal operation for the filter cake is therefore not (no longer) necessary. Instead, and taking into consideration that the filtering aid is based on the treated labels, the filter cake disposal as it were substitutes for their disposal as waste. The disposal can as such be effected by incineration or microbiologically. This is where the essential advantages are to be seen.

For the actual filtration, the processing liquid that is to be cleaned is transferred to the precoat filter as unfiltrate. The cleaned processing liquid leaves the precoat filter as filtrate. In this way all of the processing liquid can be circulated.—A device particularly suitable for the treatment of processing liquid accumulated in the course of a container cleaning is also subject-matter of the invention. The inventive method can be performed with the help of this device. The use—as filtering aid for the precoat filtration of the processing liquid that is to be cleaned—of labels obtained and treated in the course of a container cleaning with processing liquid is also subject-matter of the invention.

The invention is explained more fully below by reference to a drawing depicting just one embodiment; in the figures:

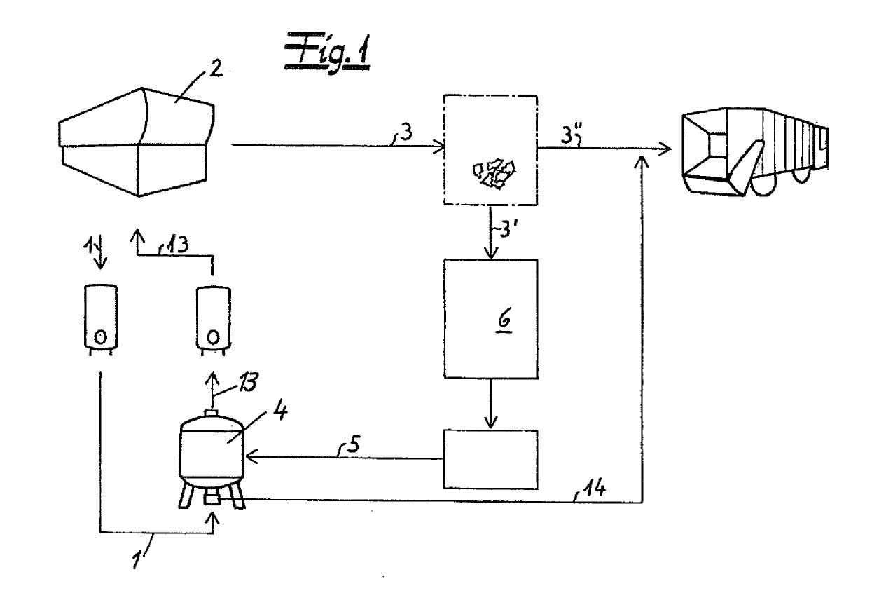

FIG. 1 shows the inventive device schematically,

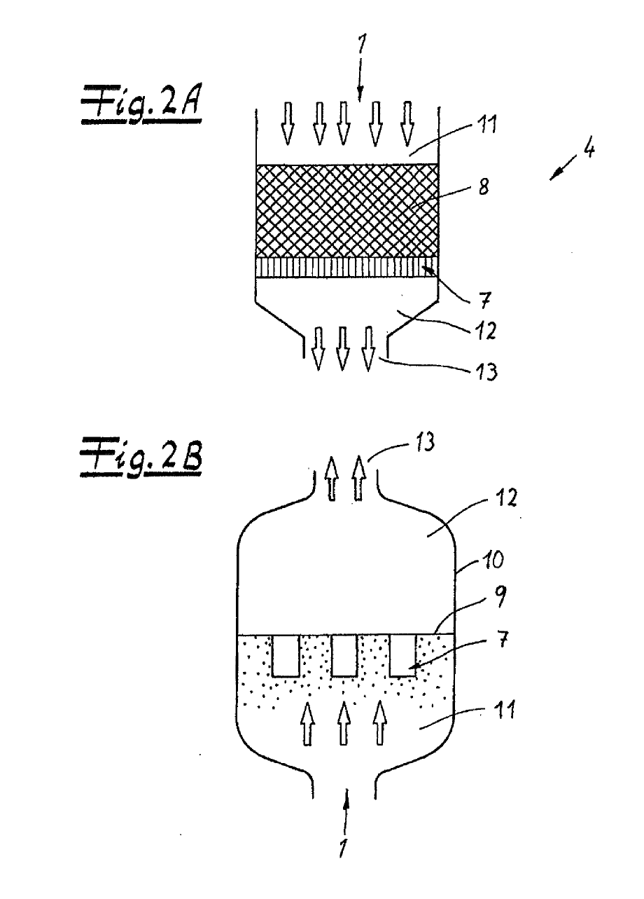

FIGS. 2a and 2b show various possible variants of the filter used, and

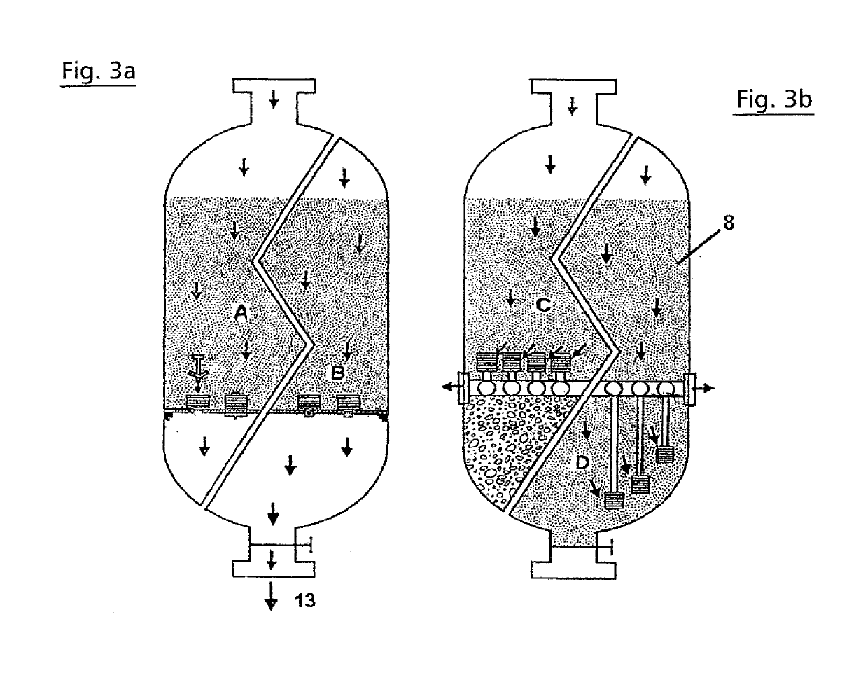

FIGS. 3a and 3b show a filter design with filter nozzles.

The figures depict a device for treating processing liquid 1. Processing liquid 1 originates from a container cleaning machine 2. Processing liquid 1 accumulates in the course of container cleaning. Container cleaning machine 2 may in fact be internally constituted as is described in the DE 10 2005 026 080 A1 referred to in the introduction.

In container-cleaning machine 2, containers and in particular re-usable containers are then guided through various treatment departments arranged sequentially in the process flow direction. These departments may be presoak baths, lye baths, spray stations and so forth. The treatment departments are traversed by re-usable bottles received in bottle cells or other transport systems. A device interacting with the individual baths for removing labels is also provided. Further details of container cleaning machine 2 are not important in the present instance however. What is decisive is the circumstance that container cleaning machine 2 on the one hand processing liquid 1 accumulated in the course of the container cleaning and on the other hand leave labels 3 detached from the containers or re-usable bottles [sic].

As well as container cleaning machine 2, the fundamental layout of the device shown in FIG. 1 includes a filter 4. According to the invention this filter 4 is configured as a precoat filter 4. Processing liquid which is to be cleaned 1 on the one hand, and a filtering aid 5 on the other, are fed to precoat filter 4. Filtering aid 5 is a cellulose filtering aid 5, i.e. filtering aid 5 works (mainly) on the basis of cellulose fibres. Within the scope of the embodiment, cellulose filtering aid 5 originates from labels 3 that are detached from the bottles or containers in the interior of container cleaning machine 2. Cellulose filtering aid 5 is in fact treated labels 3. For treating labels 3 there is provided a grinder 6 in order to condition the labels 3 in question as filtering aid or cellulose filtering aid 5 on the outlet side.

To this end, all or some of labels 3 which are detached in the course of the container cleaning and removed from container cleaning machine 2 are fed to grinder 6 in question. Labels 3 divide up into a first partial stream 3′ and a second partial stream 3″. The labels of first partial stream 3′ are prepared in grinder 6. The labels of second partial stream 3″ are directly disposed of in the embodiment. This is of course not compulsory.

Grinder 6 for example is a rotor/stator grinder as described in principle in DE 27 24 161 A1.The invention is not confined to this of course. When the first partial stream 3′ of labels 3 has been prepared and/or ground to a cellulose paste in grinder 6, desired filtering aid 5 is available for precoat filtration in precoat filter 4 on the outlet side of grinder 6. Grinder 6 may ensure that the individual cellulose fibres in the prepared filtering aid 5 exhibit a fibre length of approx. 400 μm, in any event a length which is regularly to be found below 500 μm. The shortest fibre length is regularly approx. 100 μm.

In this way it is guaranteed that filtering aid 5 can accumulate and build up perfectly on a support structure 7 in the interior of the filter or precoat filter 4. Support structure 7 is actually provided with pores which in the embodiment exhibit a diameter of less than 100 μm. In this way the invention guarantees that the cellulose fibres with a minimum fibre length of 100 μm can accumulate on the support structure. Here the cellulose fibres/filtering aid 5 form a filtration layer 8 (cf. FIG. 2a, 2b).

Filtration layer 8 filters out impurities present in the interior of processing liquid 1 that is to be treated. These impurities accumulate in filtration layer 8 and together with it form a filter cake which by operating precoat filter 4 in the opposite direction of flow can be detached from support structure 7, as previously described by way of introduction.

From a comparative consideration of FIGS. 2a and 2b it will be seen that according to the invention, it is possible to work with either a horizontal support structure/precoat filter device 7 as depicted in FIG. 2a or a vertical support structure/precoat filter device 7 as depicted in FIG. 2b. Horizontal support structure 7 is a horizontal filter screen used to configure filtration layer 8. Vertical support structure 7 as depicted in FIG. 2b on the other hand takes the form of filter candles 7 hanging on for example a partition wall 9 in the interior of a housing. These filter candles 7 may not be limited to edge filter candles. In any event filter candles 7 in the example exhibit a gap clearance which is much smaller than 100 μm in dimension so that the cellulose fibres can easily collect on the outer wall of individual filter candles 7 and form filtration layer 8.

Within the scope of the depicted example, processing liquid which is to be cleaned 1 is fed to precoat filter 4 under pressure as indicated by corresponding arrows in FIGS. 2a and 2b. Processing liquid which is to be cleaned 1 initially enters an unfiltrate space 11 of precoat filter 4 which is separated from a filtrate space 12 by the already mentioned partition wall 9 according to FIG. 2b or by support structure 7 according to FIG. 2a. Filtration layer 8 is built up as soon as processing liquid which is to be cleaned 1 and which has filtering aid 5 inside it strikes support structure 7. Any impurities present in processing liquid which is to be cleaned 1 are held back either by adhesion and/or absorption, but mainly by screening effect in filtration layer 8. The already mentioned filter cake which can be detached from associated support structure 7 by altering the direction of flow is built up as a result, after which precoat filter 4 is available for a new precoat filter operation.

The filtrate/cleaned processing liquid 13 is returned to container cleaning machine 2, as recyclate/recycled processing liquid 1, so to speak. At any event processing liquid 1 is circulated as depicted in FIG. 1. Just like labels 3 of second partial stream 3″ that are not processed into filtering aid 5, any accumulating sludge/filter cake detached from support structure 7 is passed for disposal as skimmed-off sludge 14. In other words, sludge 14/filter cake and labels 3 of the second partial stream 3″ are disposed of together because they mainly contain the same basic materials (cellulose). This reduces costs and so far as possible an incineration or a microbiological degradation.

In this way processing liquid 1 can be largely regenerated so that a significant cost saving is observed through a reduced use of processing liquid 1 or through its substitution. This is all achieved by all or some of labels 3 which are extracted and treated in the course of the container cleaning with processing liquid 1 being used as filtering aid 5 for the precoat filtration of processing liquid 1.

FIGS. 3a and 3b show a principally known arrangement of filter nozzles which approximates to the embodiment depicted in FIG. 2b. The filter nozzles are mounted on a supporting floor by way of a clamping bolt (A) or a thread (B) on the supporting floor (FIG. 3a). They may also be connected to a lateral discharge which can be configured as a standing arrangement (C) or hanging arrangement (D) (FIG. 3b). The respective embodiment greatly depends on the number of filter nozzles that are to be provided in order to ensure an effective inlet flow and outlet flow.

The filtering aid 5 in question may be equipped with a fibre length of less than 500 μm of the cellulose fibres which it contains. The dry matter in filtering aid 5 is approx. 6% by weight, usually less than 10% by weight. In other words, filtering aid 5 is a paste which is either filled directly into precoat filter 4 as shown in FIG. 1 or can also be added to processing liquid which is to be cleaned 1 before it enters precoat filter 4. A combination of these two fundamental approaches is of course also conceivable and is encompassed by the invention.

1-12. (canceled)

13. A method for treating a processing liquid accumulated in the course of cleaning a container, said method comprising adding an additive to said processing liquid, thereby forming a resulting mixture, and filtering said resulting mixture with a filtering aid for pre-coat filtration thereof, said filtering aid being at least partly obtained from labels extracted and separated during container treatment, said labels having been ground and fed to a pre-coat filter as a filtering aid.

14. The method of claim 13, further comprising adding said filtering aid as an external additive to said processing liquid.

15. The method of claim 13, further comprising adding said filtering aid as an internal additive, said internal additive originating from container treatment.

16. The method of claim 13, wherein said filtering aid comprises cellulose fibers.

17. The method of claim 13, further comprising feeding treated processing liquid that has left said pre-coat filter to a container cleaning machine.

18. The method of claim 13, further comprising transferring processing liquid to be cleaned to said pre-coat filter as un-filtrate.

19. The method of claim 13, further comprising circulating said processing liquid.

20. An apparatus for treating a processing liquid accumulated during container cleaning, said apparatus comprising a container cleaning machine having a filter, said filter being configured as a pre-coat filter to which is fed processing liquid to be cleaned, said processing liquid including a filtering aid for pre-coat filtration, a grinder, a first feeder line for feeding waste labels from said container cleaning to said grinder, a second feeder line from said grinder to said filter, and a third feeder line from conveying unfiltered lye from said container cleaning machine to said filter.

21. The apparatus of claim 20, wherein said filter is configured to receive a cellulose filtering aid obtained from labels detached by said container cleaning machine.

22. The apparatus of claim 20, wherein said filter comprises a horizontal pre-coat filter.

23. The apparatus of claim 20, wherein said filter comprises at least one vertical pre-coat filter.

24. A method of making a filtering aid for use in pre-coat filtration of a processing liquid to be cleaned, said method comprising using labels to make said filtering aid, said labels having been obtained and treated by a container treatment machine during container cleaning.
